(19) United States
(12) Patent Application Publication
(10) Pub. No.: US 2017/0080840 A1
(43) Pub. Date: Mar. 23, 2017

(54) Combination Vehicle and Apparatus for Loading and Covering Material Located on a Vehicle Bed, Apparatus for Loading Material, and/or Method for Lifting Material

(71) Applicants: William Troy Cedotal, Philadelphia, PA (US); Richard Earnest RODZWIC JR., Philadelphia, PA (US)

(72) Inventors: William Troy Cedotal, Philadelphia, PA (US); Richard Earnest RODZWIC JR., Philadelphia, PA (US)

(21) Appl. No.: 15/268,242

(22) Filed: Sep. 16, 2016

Related U.S. Application Data
(60) Provisional application No. 62/219,862, filed on Sep. 17, 2015.

(51) Int. Cl. B60P 1/48; B60J 7/16

(52) U.S. Cl. CPC B60P 1/486; B60J 7/1607

(57) ABSTRACT

A method of loading, loading apparatus, and/or combination vehicle and apparatus for loading and covering material located on a vehicle bed. The combination vehicle and apparatus for loading and covering material can include a plurality of receptacles which can follow a path when raised and lowered in which each receptacle may be rotated about and axis and lowered such that the receptacles may be filled with material at a height less than the height of the vehicle bed from the ground, and wherein the receptacles may then be raised and rotated along the same path to cause the material to be deposited in the vehicle bed and a portion of the vehicle bed to be covered by the receptacles.

### CROSS-REFERENCE TO RELATED APPLICATIONS

This application claims priority to and benefit of the following patent applications: (1) U.S. Provisional Patent Application 62/219,862, filed Sep. 17, 2015; which is hereby incorporated by reference in its entirety as if fully set forth herein.

### BACKGROUND

The present invention is generally directed toward vehicles and apparatuses for loading vehicles and, more specifically, toward vehicles designed for the transportation of materials and apparatuses designed for assisting in the loading of material into said vehicles.

Existing vehicles for transporting materials, such as pick-up trucks, suffer from many deficiencies which can be hazardous to operators health and to bystanders. Existing trucks require significant exertion by workers in order to lift material a significance distance off of the ground in order to place the material into a vehicle bed. Material must either be lifted over at least a lowest level of a vehicle bed or a lip thereof which can result in hernias and back injuries or worse. Existing trucks also transport material uncovered and exposed which endangers the public at large.

It may be advantageous to provide a method, apparatus, and/or combination vehicle and apparatus for loading materials onto a vehicle bed that: includes receptacles which can be lowered below the level of the vehicle bed; includes receptacles that can be lowered to the ground; that after filling with material, raised and inverted to deposit the material onto the bed; that can be used to both load and cover material; that is easy to use; that is readily manufactured; that reduces injuries to personnel; that reduces the amount of manpower necessary on job sites; that can lift material any significant height; and/or that provides cost savings and reduces energy consumption by providing a single multi-function apparatus.

### SUMMARY

Briefly speaking, one preferred embodiment of the present invention is directed to a combination vehicle and apparatus for loading material including a vehicle body and a vehicle bed. A plurality of receptacles, preferably shallow bins, may be movably and rotatably affixed to the vehicle bed, allowing the receptacles to move between a first transport position and a second transport position. In the first transport position, the receptacles are placed generally atop the vehicle bed with the receptacle base defining a receptacle surface, and the receptacle surface facing generally downwardly and covering a portion of the bed, forming a container for holding the material. Traveling along a set path, each receptacle preferably rotates outwardly, such that the receptacle surface faces generally upward, and then lowers vertically alongside the truck bed until reaching a predetermined height, entering the second loading position.

In another aspect, one preferred embodiment of the present invention is directed to a combination vehicle and apparatus for loading material including a plurality of receptacles that may be movably and rotatably affixed to a material support bed, allowing the receptacles to move between a first transport position and a second transport position. In the first transport position, the receptacles are placed generally atop the bed with the receptacle base defining a receptacle surface, and the receptacle surface facing generally downwardly and covering a portion of the bed, forming a container for holding the material. Each receptacle preferably rotates outwardly, such that the receptacle surface faces generally upward, and then lowers vertically alongside the truck bed until reaching a predetermined height, entering the second loading position.

In another aspect, one embodiment of the present invention is directed to a combination a vehicle and an apparatus for loading and covering material located on a vehicle bed. The vehicle bed is configured to hold the material thereon. The apparatus includes a plurality of receptacles each attached moveably and rotatably to the vehicle and each being displaceable along a path between a first transport position, in which the plurality of receptacles combine with the vehicle bed to form a container adapted to transport and/or hold the material on the vehicle bed, and a second loading position, in which the plurality of containers are positioned alongside the vehicle bed at a predetermined receptacle height which is lower than a vehicle bed height relative to a lowest vehicle level. While moving along the path between the first transport position and the second loading position each of the plurality of receptacles goes through a rotational displacement and a vertical displacement and during at least a portion of the vertical displacement the receptacle is not rotating, the vehicle bed forming a bottom side of the container and, when in the first transport position, the plurality of receptacles forming a top side of the container configured to extend above at least a portion of the bottom side. Each of the plurality of receptacles has a receptacle base defining a receptacle surface, while in the second loading position the receptacle surface faces generally upwardly and is configured to receive the material thereon, while in the first transport position the receptacle surface faces generally downwardly to form part of the container.

In another aspect, one embodiment of the present invention is directed to an apparatus for loading material. The apparatus includes a plurality of receptacles each attached moveably and rotatably to a common structure and each being displaceable along a path between a first transport position, in which the plurality of receptacles combine to form a container adapted to hold the material, and a second loading position, in which the plurality of containers are positioned at a predetermined receptacle height. While moving along the path between the first transport position and the second loading position each of the plurality of receptacles goes through a rotational displacement and a vertical displacement and during at least a portion of the vertical displacement the receptacle is not rotating.

In another aspect, one embodiment of the present invention is directed to an apparatus for loading material. The apparatus includes a plurality of receptacles each attached moveably and rotatably to a common structure and each being displaceable along a path between a first transport position, in which the plurality of receptacles combine to form a container adapted to hold the material, and a second loading position, in which the plurality of containers are positioned at a predetermined receptacle height.

One embodiment of the present invention is directed to a method of loading a vehicle including the steps of: providing a combination of the vehicle and an apparatus comprising: a vehicle bed being configured to hold material thereon; the apparatus comprising a plurality of receptacles each attached moveably and rotatably to the vehicle and each being displaceable along a path between a first transport position, in which the plurality of receptacles combine with the vehicle bed to form a container adapted to transport and/or hold the material on the vehicle bed, and a second loading position, in which the plurality of receptacles are positioned alongside the vehicle bed at a predetermined receptacle height which is lower than a vehicle bed height relative to a lowest vehicle position, wherein while moving along the path between the first transport position and the second loading position each of the plurality of receptacles goes through a rotational displacement and a vertical displacement and during at least a portion of the vertical displacement the receptacle is not rotating, the vehicle bed forming a bottom side of the container and, when in the first transport position, the plurality of receptacles forming a top side of the container configured to extend above at least a portion of the bottom side; and wherein each of the plurality of receptacles has a receptacle base defining a receptacle surface, while in the second loading position the receptacle surface faces generally upwardly and is configured to receive the material thereon, while in the first transport position the receptacle surface faces generally downwardly to form the top side of the container; moving at least one of the receptacles from the first transport position through the rotational displacement then moving that receptacle through the vertical displacement without rotating the receptacle.

One embodiment of the present invention is directed to a method of loading a vehicle including the steps of: providing a combination of the vehicle and an apparatus comprising: a vehicle bed being configured to hold material thereon; the apparatus comprising a plurality of receptacles each attached moveably and rotatably to the vehicle and each being displaceable along a path between a first transport position, in which the plurality of receptacles combine with the vehicle bed to form a container adapted to transport and/or hold the material on the vehicle bed, and a second loading position, in which the plurality of receptacles are positioned alongside the vehicle bed at a predetermined receptacle height which is lower than a vehicle bed height relative to a lowest vehicle position.

The apparatus may comprise a drive mechanism, such as a hand crank or hydraulic arm, which may power the rotation or movement of the receptacles, decreasing the amount of effort required to deposit the material on the vehicle bed.

In some aspects, the receptacles can lower to the ground, or even reach below a lowest vehicle height, particularly in cases where the vehicle may be loaded on a dock, train platform, or dig site. When the vehicle is a truck, comprising truck tires, this lowest vehicle height is the lowest height of the truck tires.

In the preferred embodiment, the apparatus comprises two receptacles, each covering approximately half of the truck bed such that the two receptacles may form a completely enclosed container in conjunction with the vehicle bed. In other embodiments, the receptacles may not fully cover the bed, or may reach a divider within the bed to form two separate subcontainers in conjunction with the vehicle bed.

In other embodiments, the vehicle may comprise three receptacles, one on each of the opposing lateral sides of the vehicle bed and a third of the rear side of the vehicle bed. Each of the said receptacles could move between the first transport position and the second loading position, and while in the first transport position, the three would fully enclose the vehicle bed to form a container.

In other aspects, the apparatus may comprise four or more receptacles, and each may be capable of moving between the first transport position and the second loading position independent of the other receptacles.

In still other aspects, the apparatus may comprise sensors on the plurality of receptacles, which may cause the drive mechanism to halt the movement of the receptacle, either rotationally or vertically, if an object is in the path of the receptacle.

### BRIEF DESCRIPTION OF THE DRAWINGS

The foregoing summary, as well as the following detailed description of the preferred embodiments of this invention, will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a frontal view of the preferred embodiment of a combination vehicle and apparatus for loading and covering material located on a vehicle bed 19, showing generally that the combination vehicle and apparatus comprises a vehicle body 20, a vehicle bed 21, and a plurality of receptacles 22 in rotatably and movably affixed to the vehicle bed 21, preferably powered by a drive mechanisms 23. The drive mechanism 23 may define a single drive system or a plurality of drive systems, such as hydraulic arms, hand cranks, electric motors, or any other drive means. In the first loading position, as depicted in FIG. 1, the receptacles 22 are positioned over the vehicle bed 21. Those of ordinary skill in the art will appreciate from this disclosure that this apparatus may be configured for use on all manner of vehicles, including but not limited to pickup trucks, dump trucks, train cars, trailers, semi-trailers, and boats. In some configurations, the vehicle may comprise truck tires 48 set upon the ground 58, defining a lowest vehicle level 56.

FIG. 2 is a front elevational view of the preferred embodiment of a combination vehicle and apparatus for loading and covering material located on a vehicle bed, with the plurality of receptacles 22 in the first transport position.

FIG. 3 is a front elevational view of the preferred embodiment of a combination vehicle and apparatus for loading and covering material located on a vehicle bed, showing the plurality of receptacles 22 transitioning into the second loading position. The plurality of receptacles 22 follow a specific path, rotating outward and then moving vertically downward to reach a specified loading height lower than the height of the vehicle bed 21.

FIG. 4 is a front elevational view of the preferred embodiment of a combination vehicle and apparatus for loading and covering material located on a vehicle bed, with a first receptacle 22a in the first transport position and a second receptacle 22b in the second loading position, being filled with material 46 for transportation, such as rock, dirt, debris, etc. This can be accomplished through independent operation of the plurality of receptacles 22, as provided in the preferred embodiment of this invention.

FIG. 5 is a top plan view of the preferred embodiment of a combination vehicle and apparatus for loading and covering material located on a vehicle bed, with a first receptacle 22a in the first transport position and a second receptacle 22b in the second loading position. The figure demonstrates that the plurality of receptacles 22 covers at least a portion of the vehicle bed 21, the vehicle bed 21 being configured to hold material 46 thereon and defining the bottom side 30 of the container 34 formed by the combination of the vehicle bed 21 and plurality of receptacles 22.

FIG. 6 is a front elevational view of the preferred embodiment of a combination vehicle and apparatus for loading and covering material located on a vehicle bed, with the plurality of receptacles 22 in the second loading position and the vehicle bed 31 open, allowing the first lateral side 26a, second lateral side 26b, front side 28a, rear side 28b, and bottom side 30 to be seen. This figure further demonstrates that the receptacle base 42 defines a receptacle surface 44 upon which material 48 can be placed, the receptacle surface 44 facing generally upward when the receptacles 22 are in the second loading position.

FIG. 7 is an overhead view of another preferred embodiment of a combination vehicle and apparatus for loading and covering material located on a vehicle bed, wherein the vehicle bed 21 further comprises a divider 40 in the vehicle bed 21, separating the bed into a plurality of subcontainers 36 when the receptacles 22 are in the first transport position.

FIG. 8 is an overhead view of another preferred embodiment of a combination vehicle and apparatus for loading and covering material located on a vehicle bed, wherein the combination vehicle and apparatus comprises four receptacles, a first receptacle 22a, a second receptacle 22b, a third receptacle 22c, and a fourth receptacle 22d. Each may be operated independently by a designated drive mechanism 23, with a first drive mechanism 23a driving the movement of the first receptacle 22a, a second drive mechanism 23b driving the movement of the second receptacle 22b, a third drive mechanism 23c driving the movement of the third receptacle 22c, and a fourth drive mechanism 23d driving the movement of the fourth receptacle 22d. The plurality of drive mechanisms 23 are preferably comprised of hydraulic systems, but those with ordinary skill in the art will appreciate that other drive means may be used without exceeding the scope of this disclosure.

FIG. 9 is an overhead view of another preferred embodiment of a combination vehicle and apparatus for loading and covering material located on a vehicle bed, wherein the combination vehicle and apparatus comprises three receptacles 22. In such an embodiment, a first receptacle 22a is positioned on a first lateral side 26a of the vehicle bed 31, a second lateral side 26b is positioned on a second lateral side 26b, and a third receptacle 22c is positioned on the rear side 28b of the vehicle bed 31. The third receptacle 22c is can be lowered behind the rear side 28b rather than along one lateral side 26 of the vehicle bed 21.

FIG. 10 is an overhead view of the preferred embodiment of a combination vehicle and apparatus for loading and covering material located on a vehicle bed, wherein the vehicle bed 21 is covered by the plurality of receptacles 22, with the first lateral side 26a, second lateral side 26b, front side 28a, and rear side 28b forming the sides of the container 34, the vehicle bed forming a bottom side of the container 30, and the plurality of receptacles 22 in the first transport position forming a top side of the container 32.

FIG. 11 is a cross sectional view of another preferred embodiment of a combination vehicle and apparatus for loading and covering material located on a vehicle bed, wherein the apparatus is in the first transport position, with a plurality of rotatable ramps 24 covering the vehicle bed 21. This embodiment is preferred for vehicles which may be loaded with material from a raised position compared to the lowest point of the vehicle, such as boats or trucks in loading docks.

FIG. 12 is a cross sectional view of another preferred embodiment of a combination vehicle and apparatus for loading and covering material located on a vehicle bed, wherein the first ramp 24a is in the first transport position and wherein the second ramp 24b is transitioning into the second loading position by beginning its rotational path into said second loading position, having rotated 90 degrees outward.

FIG. 13 is a cross sectional view of another preferred embodiment of a combination vehicle and apparatus for loading and covering material located on a vehicle bed, wherein the first ramp 24a remains in the first transport position and wherein the second ramp 24b is continuing its transition into the second loading position, having rotated 180 degrees outward, becoming fully inverted relative to its original orientation it the first transport position.

FIG. 14 is a cross sectional view of another preferred embodiment of a combination vehicle and apparatus for loading and covering material located on a vehicle bed, wherein the first ramp 24a remains in the first transport position and wherein the second ramp 24b has moved into the second transport position, having rotated 180 degrees outward and then been displaced vertically, lowering until the second ramp reached a surface such as a dock or loading dock, allow material to be pushed or carried up to the edge of the second ramp 24b and dumped directly into the vehicle bed 21.

FIG. 15 comprises a front perspective view of the preferred embodiment of a combination vehicle and apparatus for loading and covering material located on a vehicle bed, wherein the first receptacle 22a is in the second loading position, allowing the first receptacle 22a to be loaded with material 46 while the receptacle 22a is set at or below a lowest truck tire level 48. The second receptacle 22b is transitioning from the second loading position to the first transport position, having been raised vertically and then rotating such that it has rotated inward more than 90 degrees, causing the material 46 contained on the receptacle surface 44 of the second receptacle 22b to be dumped into the vehicle bed 21, being deposited therein along with the material 46 contained within the vehicle bed 21.

FIG. 15A comprises a front perspective view of the preferred embodiment of a combination vehicle and apparatus for loading and covering material located on a vehicle bed, wherein the first receptacle 22a is in the second loading position and the second receptacle 22b is in the first transport position. The figure demonstrates the path 50 that the plurality of receptacles 22 follow in transitioning between the first transport position and the second loading position, being rotationally displaced 180 degrees during the rotational displacement period 52 and vertically during the vertical displacement period 54 of the path 50.

FIG. 16 comprises a rear perspective view of the preferred embodiment of a combination vehicle and apparatus for loading and covering material located on a vehicle bed 19, wherein the plurality of receptacles 22 are in the first transport position, allowing the contents of the vehicle bed 21 to be covered during transport.

FIG. 17 is a cross sectional view of the preferred embodiment of a combination vehicle and apparatus for loading and covering material located on a vehicle bed, showing that a container 34 is formed by the first lateral side 26a, second lateral side 26b, and the vehicle bed 21 defining a bottom side 30 of the container combined with the receptacle surfaces 44 of the plurality of receptacles 22 forming a top side 32 of the container 24 when the receptacles are in the first transport position. In such an arrangement, the receptacle surface 44 of the plurality of receptacles 22 face generally downward, an inverted orientation compared to the second loading position.

FIG. 18 is a cross sectional view of another preferred embodiment of a combination vehicle and apparatus for loading and covering material located on a vehicle bed, demonstrating that when the vehicle bed 21 further comprises a divider 40, two subcontainers 36 are formed when the receptacles 22 are in the first transportation position. The first subcontainer 36a is formed by the divider 40, the first lateral side 26a, and the vehicle bed 21 defining a bottom side 30 of the container 34 combined with the receptacle surface 44 of the first receptacle 22a forming a top side 32 of the first subcontainer 24a. The second subcontainer 36b is formed by the divider 40, the second lateral side 26b, and bottom side 30 of the vehicle bed 21 combined with the receptacle surface 44 of the second receptacle 22b forming a top side 32 of the second subcontainer 24b.

### DETAILED DESCRIPTION OF THE PREFERRED EMBODIMENTS

Certain terminology is used in the following description for convenience only and is not limiting. The language “at least one of ‘A’, ‘B’, and ‘C’,” as used in the claims and/or in corresponding portions of the specification, means “any group having at least one ‘A’; or any group having at least one ‘B’; or any group having at least one ‘C’;—and does require that a group have at least one of each of ‘A’, ‘B’, and ‘C’.” Additionally, the words “a” and “one” are defined as including one or more of the referenced item unless specifically stated otherwise. The terminology includes the words above specifically mentioned, derivatives thereof, and words of similar import.

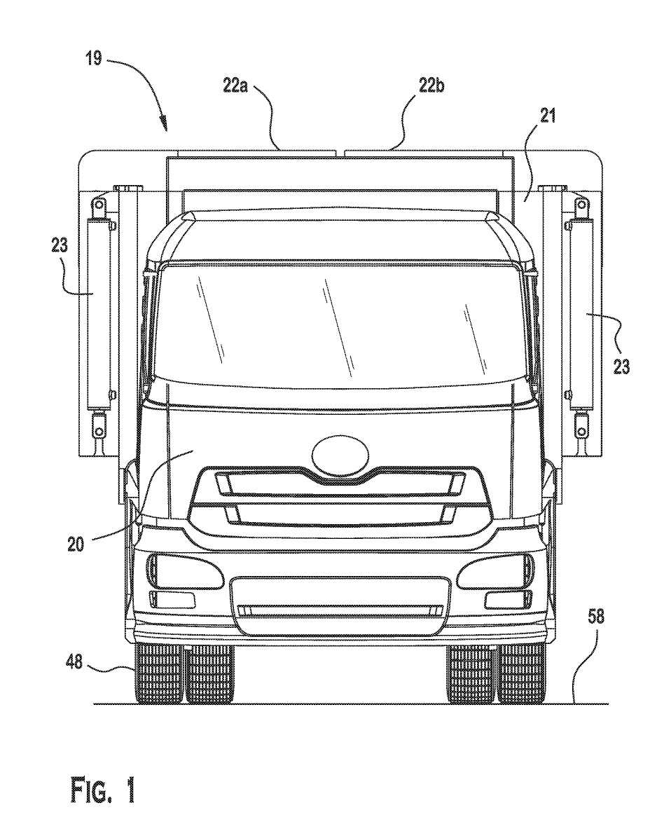

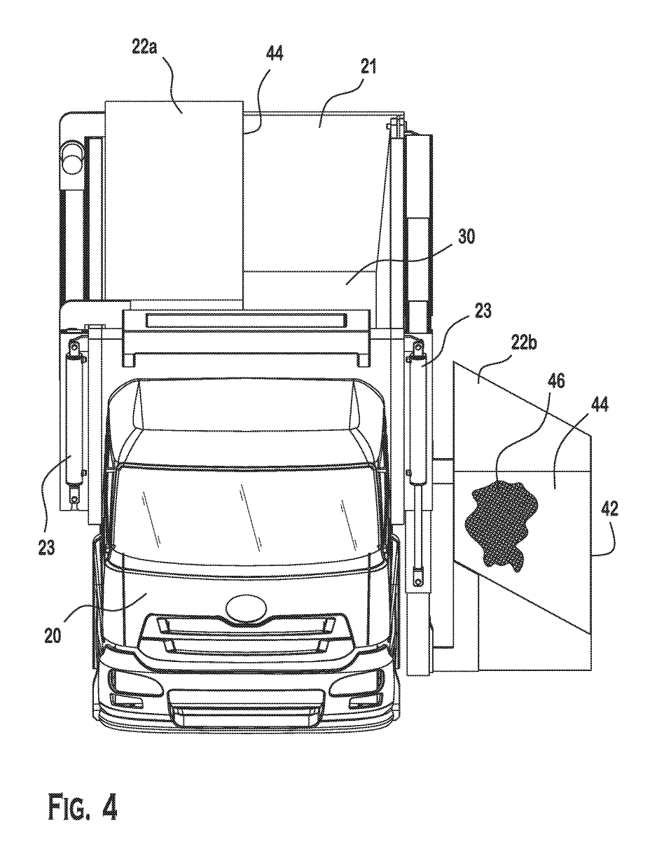

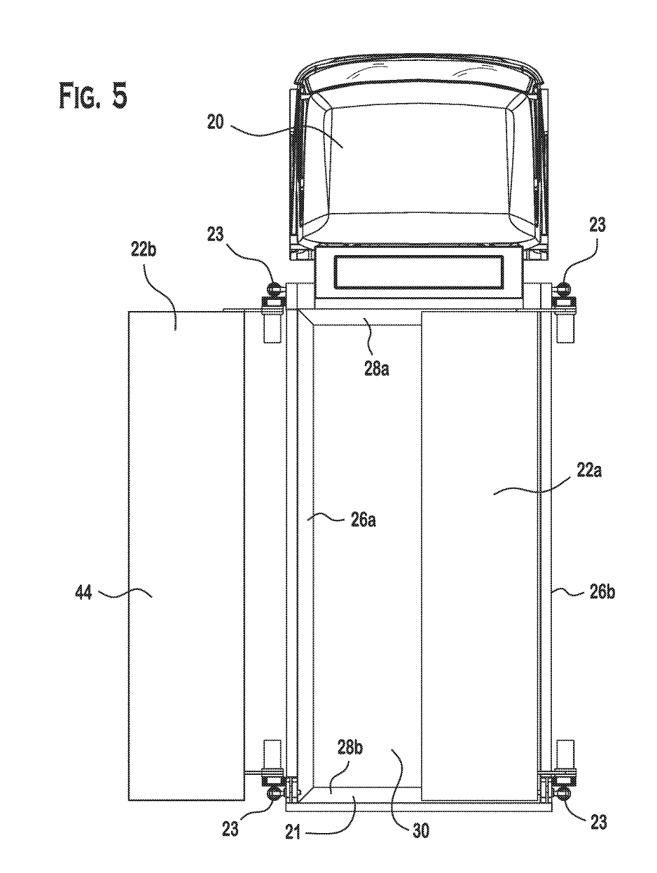

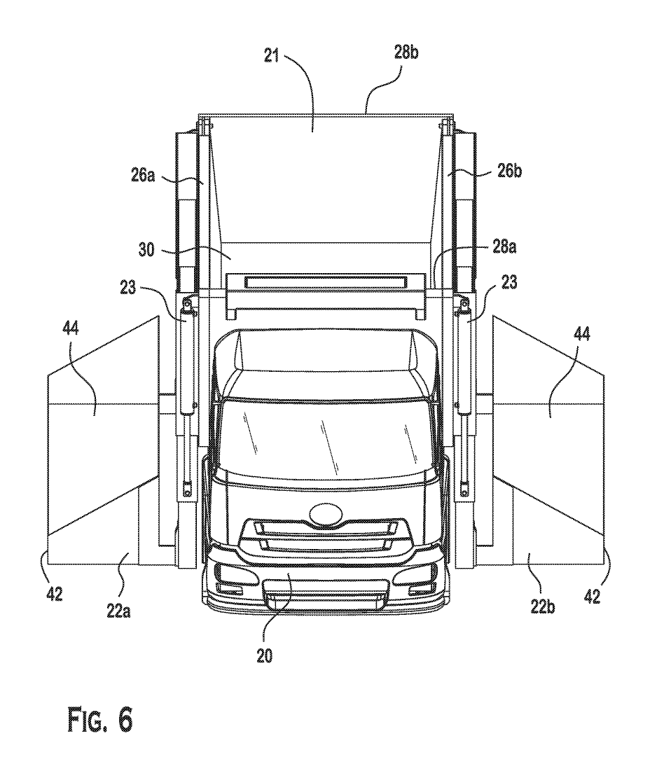

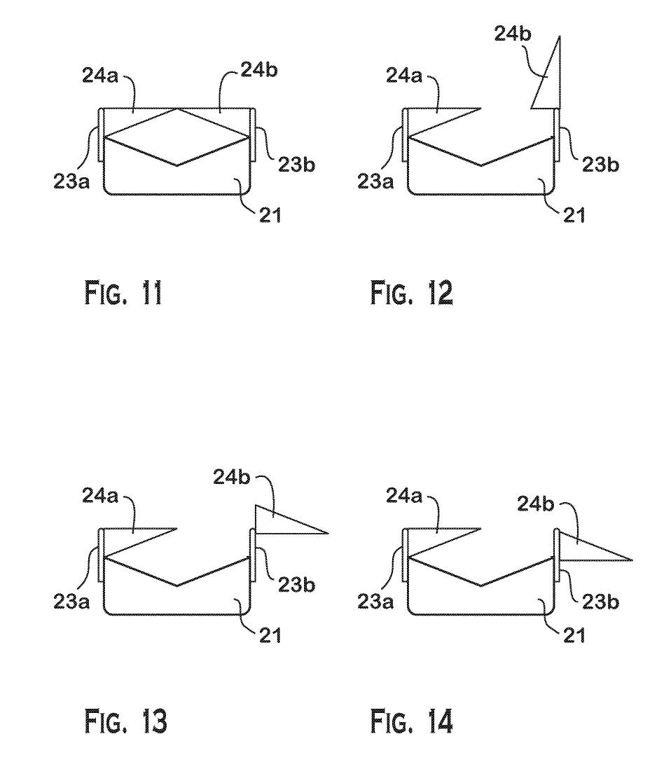

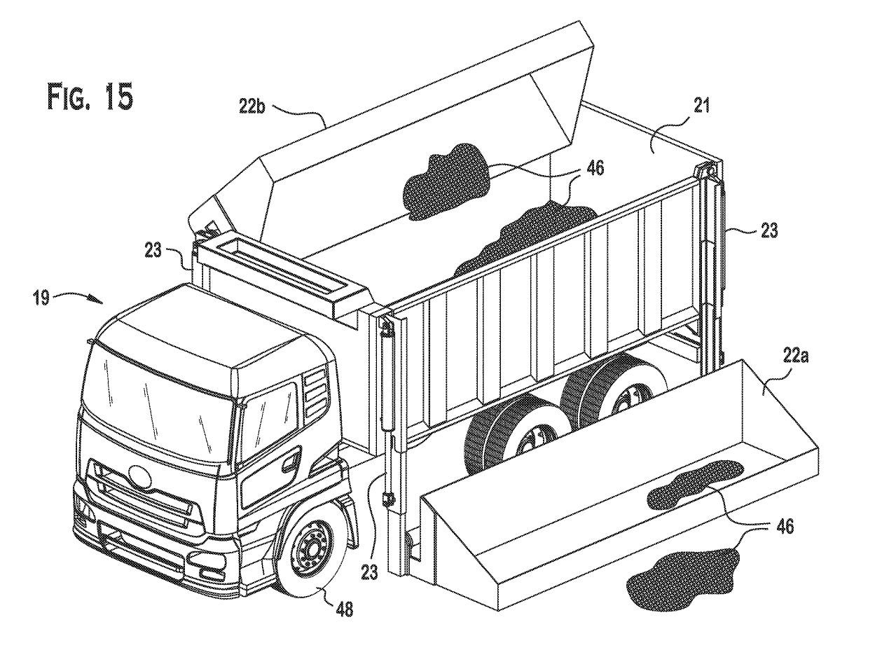

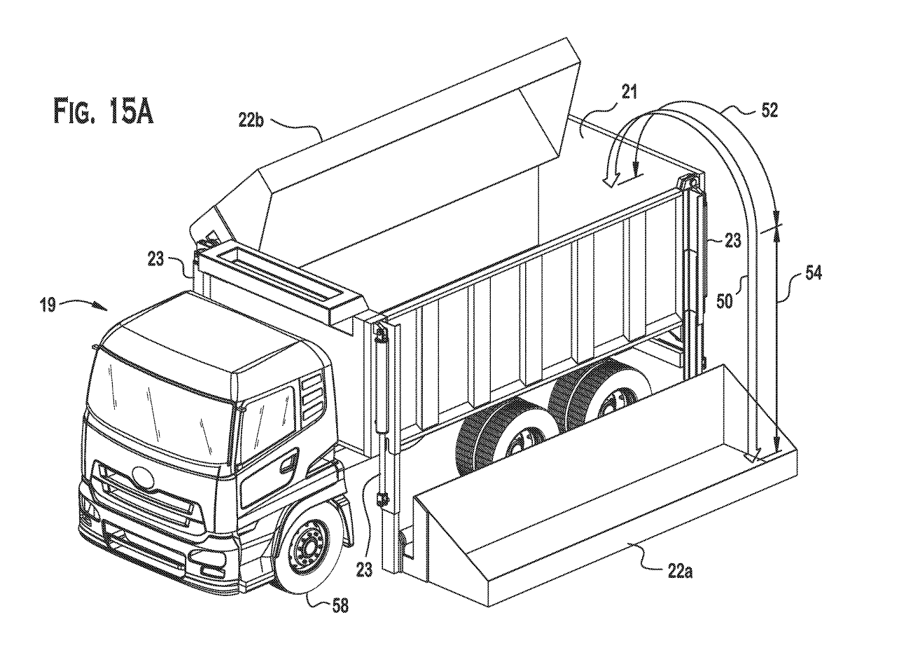

Referring to FIGS. 1-18, wherein like numerals indicate the same elements throughout, preferred embodiment for combination vehicle and an apparatus for loading and covering material located on a vehicle bed are disclosed.

Referring to FIG. 1, a combination vehicle and an apparatus for loading and covering material located on a vehicle bed 19 generally comprises a vehicle body 20 and vehicle bed 21 which is preferably configured to hold material 46 thereon. Such vehicles preferably include trucks, train cars, planes, boats, or other transport equipment. However, those with ordinary skill in the art will appreciate from this disclosure that the apparatus may be combined with any other kind of vehicle without exceeding the scope of this disclosure.

Referring to FIGS. 4 and 5 and 15, the vehicle bed is preferably further configured such that it has a bottom side 30 upon which material 46 may be placed. The bottom side 30 is preferably generally flat, to maximize the amount of material 26 which may be placed upon it. However, those with ordinary skill in the art will appreciate from this disclosure that this bottom side 30 may be generally curved, uneven, or comprising any irregular shape to facilitate shipment of all manner of material 46 without exceeding the scope of this disclosure.

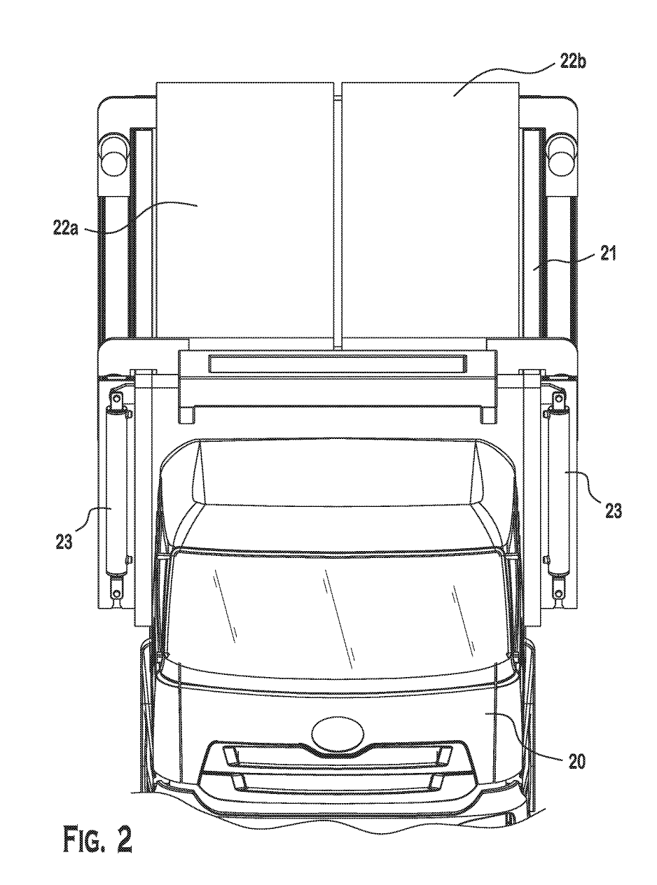

Referring to FIGS. 2-6, the vehicle bed 21 is preferably generally rectilinear, comprising four generally straight sides—opposing first and second lateral sides 26a and 26b, and opposing front and rear sides 28a and 28b. A plurality of receptacles 22 are preferably movably and rotatably attached to the vehicle bed 21 along one or more of said lateral sides 26 or rear side 28b. Those with ordinary skill in the art will appreciate from this disclosure that vehicle bed 21 need not comprise straight sides or be generally rectilinear, and may comprise any other shape provided that a plurality of receptacles 22 may be movably and rotatably affixed thereto without exceeding the scope of this disclosure. Those of ordinary skill in the art will appreciate from this disclosure that the sides may be formed by any one or combination of the vehicle, vehicle bed, and/or portions of the receptacles without departing from the scope of the present invention.

Referring to FIGS. 2 and 7-10, a preferred embodiment of the apparatus comprises a plurality of receptacles 22 rotatably affixed to a truck, comprising a truck body 20 and a bed 21, by at least one drive mechanism, such as by a plurality of hydraulic arms 23, wherein each of the plurality of receptacles 22 is attached to at least one of the plurality of hydraulic arms 22 and wherein it is preferred that no two receptacles 22 are attached to the same hydraulic arm 23. In its preferred embodiment, the apparatus comprises two receptacles, numbered 22a and 22b. It is preferred that the receptacles 22a and 22b each be half the width of the bed 21 such that, when they are closed over the bed 21, the bed 21 will be fully enclosed closed, rotatable affixed to the bed 21 of a dump truck. Those of ordinary skill in the art will appreciate from this disclosure that the number of receptacles may vary. Those of ordinary skill in the art will appreciate from this disclosure that any suitable drive mechanism can be used without departing from the scope of the present invention. For example, the drive mechanism can be electric motors, hand cranks, geared connections, etc. without departing from the scope of the present invention.

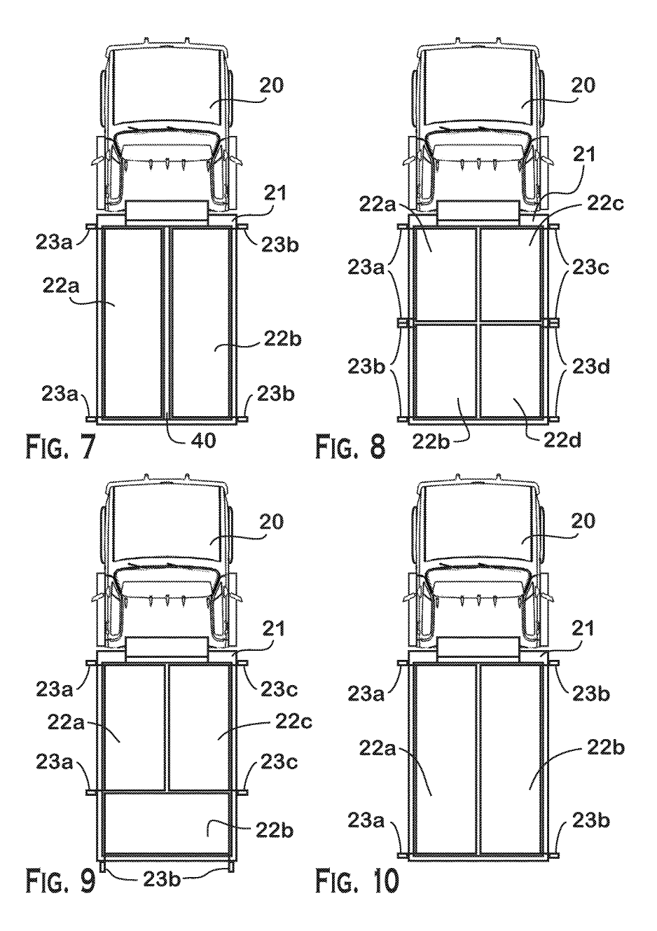

Referring to FIGS. 7-10, preferred embodiments may be configured to include varying arrangements for the plurality of receptacles 22. In the preferred embodiment, at least one of the plurality of receptacles 22a may be connected one of the first lateral side 26a, the second lateral the rears side 26b, and at least one other receptacle 22b is connected to a different one of the first lateral side 26a, the second lateral side 26b, or the rear side 28b. In other words, it is preferred that there are at least two of the plurality of receptacles 22 mounted on at least two different sides. In one embodiment, such as the one shown in FIG. 10, for example, a first receptacle 22a may be movably and rotatably attached to the first lateral side 26a and a second receptacle 22b may be movably and rotatably attached to the second lateral side 26b. The receptacles 22 in such a configuration are positioned opposite one another, allowing loading from both sides of the vehicle bed 21, as will be further disclosed below. In another configuration, such as the one shown in FIG. 9, for example, a first receptacle 22a may be movably and rotatably attached to the first lateral side 26a, a second receptacle 22b may be movably and rotatably attached to the second lateral side 26b, and a third receptacle 22c may be movably and rotatably attached to the rear side 38b, thus providing at least one of the plurality of receptacles 22 on three of the four sides of the vehicle bed 21. In another configuration, such as the one shown in FIG. 8, for example, a first receptacle 22a and a second receptacle 22b may be movably and rotatably attached to the first lateral side 26a, and a third receptacle 22c and fourth receptacle 22d may be movably and rotatably attached to the second lateral side 26b, thus having four receptacles affixed to the vehicle bed 21. In this and other similar embodiments, the plurality of receptacles 2 may be independently operable of one another, or may be configured to operate in unison. Those of ordinary skill in the art will appreciate from this disclosure that other configurations of the plurality of receptacles, such as the provision of more than four receptacles, or the plurality of receptacles 22 affixed to only the rear side 28a and one lateral side 26 without exceeding the scope of this disclosure.

Referring to FIGS. 2-6 and 15-16, the plurality of receptacles 22 are preferably configured to have two positions, a first transport position and a second loading position, being able to alternate between these positions by following a displacement path 50. The receptacles 22 are preferably displaceable along a path 50, beginning first in a first transport position in which the plurality of receptacles 22 combine with the vehicle bed 21 to form a container 34 adapted to transport and/or hold material 46 on the vehicle bed 21. The plurality of receptacles 22, in following the path 50 to the second loading position, would first undergo the rotational displacement portion 52 of the path 50, rotating roughly 180 degrees outward and then the vertical displacement portion 54 of the path 50, lowering to a predetermined receptacle height, the second loading position. During at least a portion of the vertical displacement portion 54, it is preferred that the receptacle 22 is not rotating. The predetermined receptacle height is lower than the height of the vehicle bed 21 relative to a lowest vehicle level 56. For vehicles such as a truck, this lowest vehicle level 56 is the lowest point on the truck tire 48. It is preferred that the predetermined receptacle height is roughly the level of the ground 58, such that the plurality of receptacles 22 can be positioned at ground 58 level when in the second loading position. However, in some embodiments, the predetermined receptacle height may be lower than the lowest vehicle level 56, such that the plurality of receptacles 22 may be positioned lower than the lowest vehicle level 56 when in the second loading position. This may be useful when a vehicle is being loaded from a raised position, such as if the vehicle is at the top of a ramp, at a dig site, or similar. For example, in one preferred embodiment the receptacles can be lowered a distance equal to the height of the vehicle bed 21 (relative to the lowest vehicle level 56) below the lowest vehicle level. Alternatively, the receptacles 22 can be lowered a distance between 20 percent to 80 percent of the height of the vehicle bed 21 (relative to the lowest vehicle level 56) below the lowest vehicle level. Alternatively, the receptacles 22 can be lowered a distance between 60-90 percent of the height of the vehicle bed 21 (relative to the lowest vehicle level 56) below the lowest vehicle level. Alternatively, the receptacles 22 can be lowered a distance between 110-190 percent of the height of the vehicle bed 21 (relative to the lowest vehicle level 56) below the lowest vehicle level. Those of ordinary skill in the art will appreciate from this disclosure that that distance that a receptacle 22 can be lowered past the lowest vehicle level 56 can be varied without departing from the scope of the present invention.

Referring to FIGS. 4, 15, 15A, and 17 it is preferred that the plurality of receptacles 22 may follow the same path 50, in the inverse, in moving from the second loading position into the first transport position. The receptacles 22 may be loaded with material 46 in the second loading position, and then raised along the vertical displacement portion 54 of the path 50. The receptacle 22 may then be rotated within the rotational displacement portion 52 of the path 50, causing the receptacle 22 to rotate roughly 180 degrees, allowing the material 46 to fall into the vehicle bed 21 as the receptacle 22 enters the first transport position. To best illustrate the rotation of the receptacle 22 during the path 30, the receptacles 22

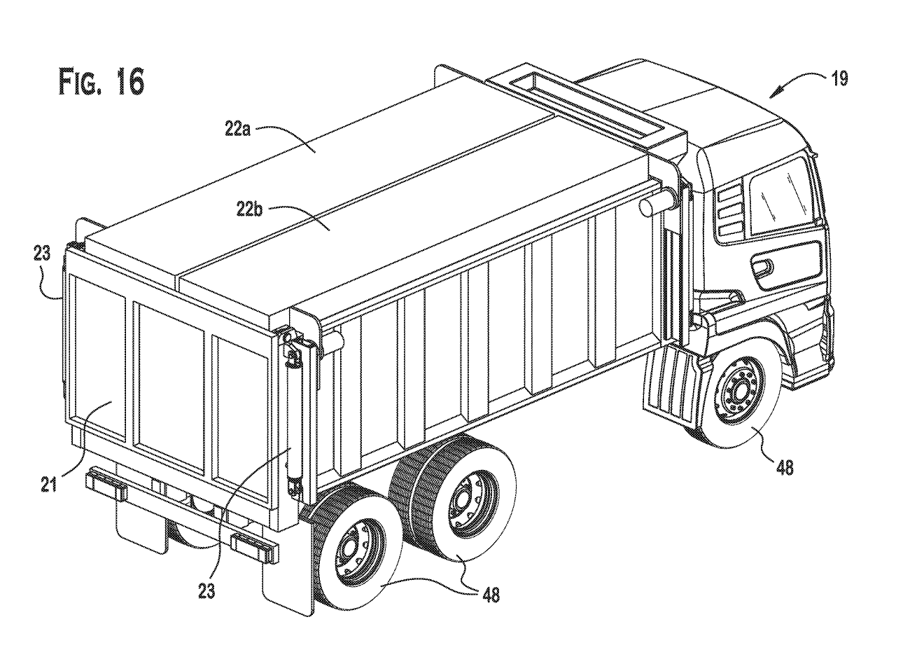

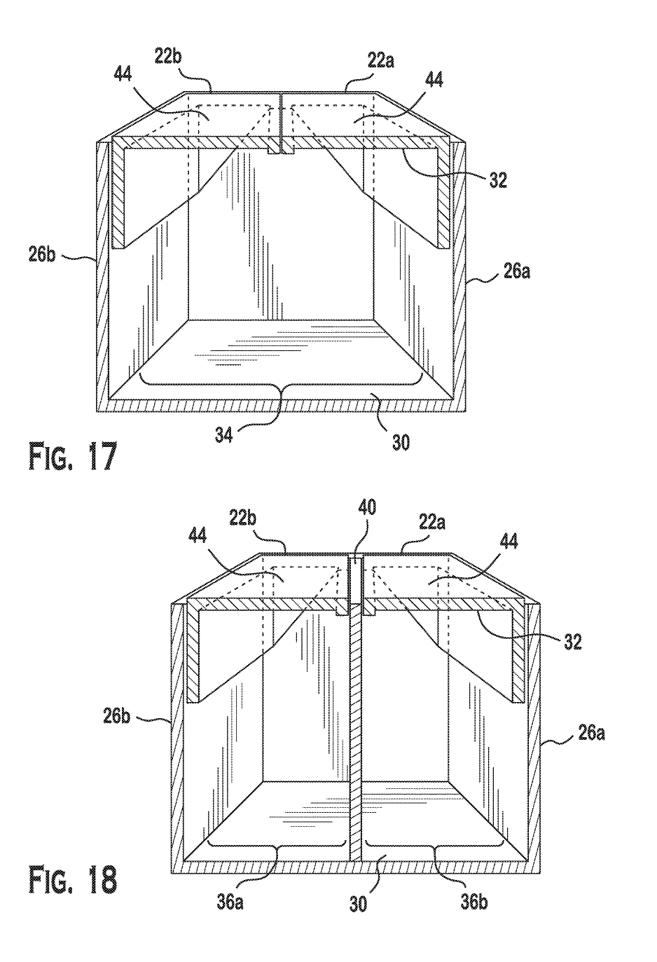

Referring to FIGS. 16-18, the receptacles 22 may act as a cover for the truck bed/boat deck/vehicle bed 21 when in the first transport position. As can be seen in FIG. 17, the each of the receptacles 22 has a base 42 which further defines a receptacle surface, 44 a preferably flat are upon which material 46 can be place when the receptacle 22 is in the second loading position. Thus, when a receptacle 22 is in second loading position, the receptacle surface 44 faces generally upward. As the receptacle 22 moves along the path 30 and reaches the rotational displacement portion 52, the receptacle 22 rotates, and when the receptacle 22 is in the first transport position, the receptacle surface 44 faces generally downward, toward the bottom side 30 of the vehicle bed 21. This is generally an inverted position from the second loading position. When in the first transport position, it is preferred that plurality of receptacles 22 extend above at least a portion of the bottom side 30 of the vehicle bed 21, forming a container 34 in conjunction with the first lateral side 26a, second lateral side 26b, and bottom side 30 of the vehicle bed 21. In such a configuration, the receptacle surface 44 may form the top side 32 of the container 34 when the receptacles are in the first transport position.

Referring to FIGS. 17 and 18, it is preferred that the plurality of receptacles 22 extend above all of the bottom side of the container 34 in the first transport position, forming a complete top side 32 of the container 34. However, in some embodiments, it is preferred that the plurality of receptacles 22 do extend above all of the bottom side 30 of the container 34 in the first transport position, particularly when the vehicle bed 21 further comprises at least one divider thereon. In such an embodiment, the receptacles 22 may only extend to cover a portion of the bottom side 30 of the truck bed 21 and may still form a complete top side 32, each forming a top side 32 of a plurality of subcontainers 36 that are separately accessible from each other. These subcontainers 36 are formed when the receptacles 22 are in the first transportation position. The first subcontainer 36a is formed by the divider 40, the first lateral side 26a, and bottom side 30 of the vehicle bed 21 combined with the receptacle surface 44 of the first receptacle 22a forming a top side 32 of the first subcontainer 24a. The second subcontainer 36b is formed by the divider 40, the second lateral side 26b, and bottom side 30 of the vehicle bed 21 combined with the receptacle surface 44 of the second receptacle 22b forming a top side 32 of the second subcontainer 24b. In some embodiments, the divider 40 may be detachably engageable with the vehicle bed, allowing the apparatus to form one container 34 or a plurality of subcontainers 36. It is preferred that the divider 40 be detachably engageable through a temporary affixing means, such as the provision of a lip in the truck bed 21 for the divider 40 to slidably engage with. However, those of ordinary skill in the art will appreciate from this disclosure that other affixing means may be provided without exceeding the scope of this disclosure.

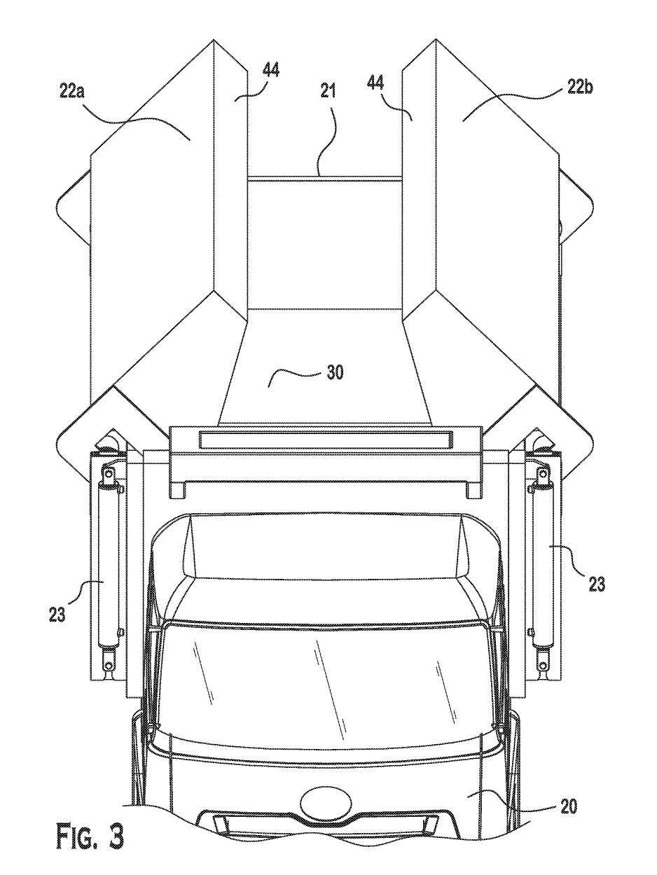

Referring to FIGS. 3 and 7-10, the plurality of receptacles 22 are preferably configured to be moved along the path 50 by a plurality of drive mechanisms 23 connecting the plurality of receptacles 22 to the vehicle bed 21. The plurality of drive mechanisms 23 may include a plurality of hydraulics used to rotate and or vertically adjust each of the plurality of receptacles 22, such as hydraulic arms, or other drive mechanisms 23 including but not limited to electric motors, hand operated cranks, or any other drive mechanisms. Those of ordinary skill in the art will appreciate from this disclosure that other drive mechanisms may be provided without exceeding the scope of this disclosure. It is preferred that no more than one of the plurality of receptacles 22 is affixed to each of the plurality of drive mechanisms 23, and that each of the plurality of receptacles 22 is affixed to at least one of the plurality of drive mechanisms 23. For example, in FIG. 8, the apparatus comprises four receptacles, 22a, 22b, 22c, and 22d. Each of the receptacles 22 is affixed to a drive mechanism 23, and no two of the receptacles 22 are affixed to the same drive mechanism 23. Thus, the first receptacle 22a is affixed to the first drive mechanism 23a (pictured comprising two hydraulic arms), the second receptacle 22b is affixed to the second drive mechanism 23b, the third receptacle 22c is affixed to the third drive mechanism 23c, and the fourth receptacle 22d is affixed to the fourth drive mechanism 23d. The drive mechanisms 23 are preferably capable of moving each of the plurality of receptacles 22 separately from the others, allowing the receptacles 22 to move between the first transport position and the second loading position independent of one another. However, in some embodiments, the drive mechanisms 23 may be capable of moving all of the plurality of receptacles 22 in unison, to simplify controls or to ensure that the plurality of receptacles 22 remain in the same position as any or all other receptacles 22.

Referring to FIGS. 3-4 and 15A, some embodiments of the present invention may include the plurality of receptacles 22 further comprising at least one sensor configured to detect collision with an object when moving from the first transport position into the second loading position. It is preferable that each of the plurality of receptacles 22 comprising at least one sensor further comprise the sensor being configured to signal a controller prior to collision, with this controller being configured to automatically halt motion of the associated receptacle 22 prior to collision. This configuration may be include as a safety feature to ensure that the receptacles 22 do not cause damage to persons or property when moving between the first transport position and the second loading position. In some embodiments, the sensor may be configured to automatically stop movement of the receptacles 22 when travelling along the path 50 is collision is detected in either direction. The sensor may be configured to stop motion of all receptacles 22 or only of the receptacle for which collision is detected.

Referring to FIGS. 11-14, another preferred embodiment of the present invention comprises use of a plurality of ramps 24 in the place of receptacles 22, in which the ramps 24 may transition from a first transport position, wherein the ramps 24 cover the vehicle bed 21, and a second loading position, wherein the ramps have rotated and outwardly and lowered to allow material 46 to be pushed or carried up the ramps 24 and deposited directly into the vehicle bed 21. It is preferred that the ramps be controlled separately, such that the first ramp 24a may be remain in the first transport position without being moved by the first drive mechanism 23a while the second ramp 24b is moved by the second drive mechanism 23b into the second loading position, or vice versa. Such an embodiment would allow vehicle bends to be accessed only from one side, if access is only available from a single side, such as if the vehicle is a boat moored to a dock only on a single side, or if the vehicle is a train, and the vehicle bed 21 is accessible from the train platform only on a single side. This embodiment is preferred for vehicles which may be loaded with material from a raised position compared to the lowest point of the vehicle, such as boats or trucks in loading docks, or from a scaffolding. Those of ordinary skill in the art will appreciate from this disclosure that temporary vehicle beds, such as dumpsters or semi-trailers, which may be removed from the vehicle and placed in a lower location than material 46 to facilitate loading, without exceeding the scope of this disclosure.

The present invention further comprises a method of loading a vehicle, comprising several preferred embodiments. Preferred implementations of preferred methods of the present invention will be described below (alone or in combination with various embodiments of the apparatus. The steps of the method of the present invention can be performed in any order, omitted, or combined without departing from the scope of the present invention. As such, optional or required steps described in conjunction with one implementation of the method can also be used with another implementation or omitted altogether. Additionally, unless otherwise stated, similar structure or functions described in conjunction with the below method preferably, but not necessarily, operate in a generally similar manner to that described elsewhere in this application.

In a preferred embodiment, the method of loading a vehicle comprises the following steps.

The first step is the provision of a combination vehicle and an apparatus for loading and covering material located on a vehicle bed 19 comprising: a vehicle bed 21 that is configured to hold material thereon and is preferably a generally surface; a plurality of receptacles 22 which are each moveably and rotatably attached to the vehicle and each being displaceable along a path 50 between a first transport position, in which the plurality of receptacles combine 22 with the vehicle bed 21 to form a container 34 designed hold material 46 on the vehicle bed 21 during transport, and a second loading position, in which the plurality of receptacles 22 are positioned alongside the vehicle bed 21 at a predetermined receptacle height which is lower than the height of the vehicle bed 21 relative to a lowest vehicle level, such as the lowest point of a truck tire 48 relative to the ground, and wherein when moving between the first transport position and the second loading position each of the plurality of receptacles 22 follows a set path 50 in going through a rotational displacement portion 52 and a vertical displacement portion 54 of this transition, and during at least a portion of the vertical displacement portion 54 the receptacle 22 is not rotating, the vehicle bed 21 forms a bottom side 30 of the container 34, and, when in the first transport position, the plurality of receptacles 22 forms a top side 32 of the container 34 configured to extend above at least a portion of the bottom side 30; and wherein each of the plurality of receptacles 22 has a receptacle base 42 which defines a receptacle surface 44, a generally flat surface upon which material 46 may be placed while in the second loading position as the receptacle surface is configured to face generally upwardly while in the second loading position, and face generally downward while in the first transport position.

The second step comprises moving at least one of the receptacles 22 from the first transport position through the rotational displacement portion 52 and vertical displacement portion 54 of the predetermined path 50 without rotating the receptacle until the receptacle is in the first transport position.

In other embodiments, this method may further include the additional step of loading material 46 onto at least one of the receptacles 22 while said receptacle 22 is in the second loading position.

In other embodiments, this method may further include the additional step of moving the loaded receptacle 22 upwards along the predetermined path 50 to transition the receptacle 22 to the first transport position, causing the receptacle 22 to pass through the vertical displacement portion 54 of the path 50, and then through the rotational displacement portion 52 of the path 50, causing the receptacle 22 to rotate inward and causing the receptacle 22 to dump the material 46 therein into the vehicle bed 21 while the receptacle 22 rotates into the first transport position and forms the top side 32 of the container 34.

While various shapes, configurations, and features have been described above and shown in the drawings for the various embodiments of the present invention, those of ordinary skill in the art will appreciate from this disclosure that any combination of the above features can be used without departing from the scope of the present invention. It is understood, therefore, that this invention is not limited to the particular embodiments disclosed, but is intended to cover all modifications which are within the spirit and scope of the invention as defined by the appended claims and/or shown in the attached drawings.

What is claimed is:

1. A combination a vehicle and an apparatus for loading and covering material located on a vehicle bed, comprising:
the vehicle bed being configured to hold the material thereon;
the apparatus comprising a plurality of receptacles each attached moveably and rotatably to the vehicle and each being displaceable along a path between a first transport position, in which the plurality of receptacles combine with the vehicle bed to form a container adapted to transport and/or hold the material on the vehicle bed, and a second loading position, in which the plurality of containers are positioned alongside the vehicle bed at a predetermined receptacle height which is lower than a vehicle bed height relative to a lowest vehicle level, wherein while moving along the path between the first transport position and the second loading position each of the plurality of receptacles goes through a rotational displacement and a vertical displacement and during at least a portion of the vertical displacement the receptacle is not rotating, the vehicle bed forming a bottom side of the container and, when in the first transport position, the plurality of receptacles forming a top side of the container configured to extend above at least a portion of the bottom side; and
wherein each of the plurality of receptacles has a receptacle base defining a receptacle surface, while in the second loading position the receptacle surface faces generally upwardly and is configured to receive the material thereon, while in the first transport position the receptacle surface faces generally downwardly to form part of the container.

2. The combination of claim 1, wherein the apparatus is configured such that the plurality of receptacles can be positioned at ground level when in the second loading position.

3. The combination of claim 1, wherein the vehicle is a truck and the apparatus is configured such that the plurality of receptacles can be positioned at below the lowest vehicle level.

4. The combination of claim 2, wherein the vehicle bed is generally rectilinear with opposing first and second lateral sides and opposing front and rear sides, at least one of the plurality of receptacles being connected to one of: the first lateral side, the second lateral sides, and the rear side; at least another of the plurality of receptacles being connected to a different one of: the first lateral side, the second lateral sides, and the rear side.

5. The combination of claim 4, wherein the apparatus comprises a third receptacle connected to one of a different one of: the first lateral side, the second lateral sides, and the rear side from the one and another of the plurality of receptacles.

6. The combination of claim 2, wherein the plurality of receptacles comprises at least four independently operable receptacles.

7. The combination of claim 1, wherein the plurality of receptacles forming the top side of the container are configured to extend above all of the bottom side of the container.

8. The combination of claim 2, wherein the vehicle bed includes at least one divider thereon to, in combination with the plurality of receptacles, form a plurality of subcontainers that are separately accessible from each other.

9. The combination of claim 7, wherein the vehicle bed includes at least one divider thereon to, in combination with the plurality of receptacles, form a plurality of subcontainers that are separately accessible from each other.

10. The combination of claim 9, wherein the at least one divider is detachably engageable with the vehicle bed.

11. The combination of claim 2, further comprising at least one drive mechanism connecting the plurality of receptacles to the vehicle.

12. The combination of claim 11, wherein the at least one drive mechanism further comprises a plurality of hydraulics used to rotate and/or vertically adjust each of the plurality of receptacles.

13. The combination of claim 2, wherein each of the plurality of receptacles further comprises at least one sensor configured to detect collision with an object when moving into the second loading position.

14. The combination of claim 12, wherein each of the plurality of receptacles further comprises at least one sensor configured to detect collision with an object when moving into the second loading position, the at least one sensor being configured to signal a controller prior to collision, the controller being configured to halt motion of the associated receptacle prior to collision.

15. The combination of claim 11, wherein the drive mechanism is capable of moving each of the plurality of receptacles separately from the others.

16. The combination of claim 11, wherein the at least one drive mechanism is capable of moving all of the plurality of receptacles in unison.

17. A method of loading a vehicle, comprising:
providing a combination of the vehicle and an apparatus comprising:
a vehicle bed being configured to hold material thereon;
the apparatus comprising a plurality of receptacles each attached moveably and rotatably to the vehicle and each being displaceable along a path between a first transport position, in which the plurality of receptacles combine with the vehicle bed to form a container adapted to transport and/or hold the material on the vehicle bed, and a second loading position, in which the plurality of receptacles are positioned alongside the vehicle bed at a predetermined receptacle height which is lower than a vehicle bed height relative to a lowest vehicle position, wherein while moving along the path between the first transport position and the second loading position each of the plurality of receptacles goes through a rotational displacement and a vertical displacement and during at least a portion of the vertical displacement the receptacle is not rotating, the vehicle bed forming a bottom side of the container and, when in the first transport position, the plurality of receptacles forming a top side of the container configured to extend above at least a portion of the bottom side; and
wherein each of the plurality of receptacles has a receptacle base defining a receptacle surface, while in the second loading position the receptacle surface faces generally upwardly and is configured to receive the material thereon, while in the first transport position the receptacle surface faces generally downwardly to form the top side of the container;
moving at least one of the receptacles from the first transport position through the rotational displacement then moving that receptacle through the vertical displacement without rotating the receptacle.

18. The method of claim 17, further comprising the step of loading material onto the at least one of the receptacles in the second loading position.

19. The method of claim 18, further comprising the step of moving the loaded receptacle upwards through vertical displacement and then rotating the receptacle so as to dump the material therein into the vehicle bed while rotating the receptacle into the first transport position to form the top side of the container.
